(19) United States
(12) Patent Application Publication
(10) Pub. No.: US 2019/0242605 A1
(43) Pub. Date: Aug. 8, 2019

(54) CONTROLLING A HEATING, VENTILATION AND AIR CONDITIONING (HVAC) SYSTEM WITH NETWORKED HVAC ZONE SENSORS

(71) Applicant: Carrier Corporation, Palm Beach Gardens, FL (US)

(72) Inventors: Chandra Shekhar Nalajala, Hyderabad (IN); Srinivas Padilam, Vijawavada (IN)

(21) Appl. No.: 16/033,850

(22) Filed: Jul. 12, 2018

(30) Foreign Application Priority Data
Feb. 8, 2018 (IN) 201811004880

(51) Int. Cl. F24F 11/46; F24F 11/52; F24F 11/54; F24F 11/58; F24F 11/65; G05B 11/01

(52) U.S. Cl. CPC F24F 11/46; F24F 11/52; F24F 11/54; F24F 2120/12; F24F 11/65; G05B 11/01; F24F 11/58

(57) ABSTRACT

Disclosed is an HVAC system with networked HVAC zone sensors, and HVAC zone controllers communicating with portable smart devices over personal area networks, wherein the portable smart devices are registered with an HVAC controller and assigned to device groups, each of the HVAC zone controllers is paired with each of the portable smart devices, each of the HVAC zone controllers scans to determine whether, and how many of, the portable smart devices are within communication range, the HVAC controller communicates with each of the HVAC zone controllers to determine the results of the scans, and the HVAC controller controls the HVAC system based on the results accounting for how many of the portable smart devices detected by the HVAC zone controllers are subsumed under one or more of the device groups.

### CROSS REFERENCE TO RELATED APPLICATIONS

This application claims the benefit of an earlier filing date from Indian Provisional Application No. 201811004880 filed Feb. 8, 2018, the entire disclosure of which is incorporated herein by reference.

### BACKGROUND

The disclosed embodiments relate to controlling a heating, ventilation and air conditioning (HVAC) system and more specifically to controlling an HVAC system with networked HVAC zone sensors.

Selective activation of HVAC systems is desirable to save energy when a room is not occupied. HVAC systems are capable of being activated by occupancy sensors using PIR (passive infrared) sensors that detect motion to determine when there is room occupancy. PIR sensors sense the difference in heat emitted by humans in motion from that of the background space. These sensors detect motion within a field of view that requires a line of sight; such sensors cannot “see” through obstacles in a room and have limited sensitivity to minor (hand) movement at distances typically greater than the size of a small room.

Installing a PIR sensor in every room, or multiple sensors in a single room, is technically and financially challenging. If the PIR sensors are battery powered, then periodically replacing sensors becomes an additional challenge. In addition, in large rooms with multiple zones, such as large auditoriums, a PIR sensor is incapable of determining the difference between one user or many people in a room, and is also incapable of determining the location of the people relative to a specific zone for selectively controlling HVAC systems.

### BRIEF DESCRIPTION

Disclosed is a system for automatically controlling a Heating, Ventilation and Air Conditioning (HVAC) system with networked HVAC zone sensors, the HVAC system being within a building, the building containing a plurality of partitioned spaces and a plurality of HVAC zones positionally associated with the plurality of partitioned spaces, the system including: an HVAC controller controlling the HVAC system, a plurality of zone controllers disposed within at least one of the plurality of HVAC zones, the HVAC controller communicating with the plurality of zone controllers via Ethernet protocols and/or local area network (LAN) protocols, and the plurality of zone controllers communicating with a plurality of portable smart devices over a personal area network (PAN), wherein: the plurality of portable smart devices are registered to an HVAC controller and assigned to a plurality of device groups, each of the plurality of zone controllers is paired with each of the plurality of portable smart devices, each of the plurality of zone controllers scans to determine whether, and how many of, the plurality of portable smart devices are within communication range, the HVAC controller communicates with each of the zone controllers to determine the results of the scans, and the HVAC controller controls the HVAC system based on the results accounting for how many of the plurality of portable smart devices detected by the plurality of zone controllers are subsumed under one or more of the plurality of device groups.

In addition to one or more of the above disclosed features, or as an alternative, the plurality of partitioned spaces includes a first partition space, the plurality of HVAC zones includes a first HVAC zone for conditioning at least a first portion of the first partition space, the plurality of zone controllers includes a first HVAC zone controller positionally associated with the first HVAC zone, and the plurality of portable smart devices includes a first portable smart device, and wherein: the HVAC controller controls the HVAC system to condition air in the first HVAC zone when the first HVAC zone controller determines the first portable smart device is within communication range.

In addition to one or more of the above disclosed features, or as an alternative, the HVAC controller controls a first magnitude of conditioning air in the first HVAC zone depending on how many portable smart devices from the plurality of portable smart devices are within communication range of the first HVAC zone controller.

In addition to one or more of the above disclosed features, or as an alternative, the first magnitude of conditioning of air in the first HVAC zone is a function of graduated threshold scale comparing how many portable smart devices from the plurality of portable smart devices are within communication range of the first HVAC zone controller against output needs in the first HVAC zone.

In addition to one or more of the above disclosed features, or as an alternative, the HVAC controller controls the HVAC system to stop conditioning air in the first HVAC zone or to condition air in an economizer mode in the first HVAC zone when the first HVAC zone controller detects no portable smart devices are within communication range.

In addition to one or more of the above disclosed features, or as an alternative, the plurality of HVAC zones includes a second HVAC zone for conditioning at least a second portion of the first partition space, the plurality of zone controllers includes a second HVAC zone controller positionally associated with the second HVAC zone, and wherein: the HVAC controller controls the HVAC system to condition air in both the first HVAC zone and second HVAC zone when either of the first HVAC zone controller and the second HVAC zone controller determines the first portable smart device is within communication range.

In addition to one or more of the above disclosed features, or as an alternative, the HVAC controller controls the HVAC system so that the first magnitude of conditioning air in the first HVAC zone differs from a second magnitude of conditioning air in the second HVAC zone.

In addition to one or more of the above disclosed features, or as an alternative, the first magnitude of conditioning air in the first HVAC zone is greater than the second magnitude of conditioning air in the second HVAC zone when more of the plurality of portable smart devices are within communication range of the first HVAC zone controller than within range of the second HVAC zone controller.

In addition to one or more of the above disclosed features, or as an alternative, the plurality of portable smart devices includes a second portable smart device, and wherein: the first portable smart device and the second portable smart device are registered with the HVAC controller as a first group of portable smart devices, the HVAC controller system determines that the first HVAC zone controller detects that the first portable smart device is within communication range of the first zone controller and the second HVAC zone controller detects that the second portable smart device is within communication range of the second zone controller, the HVAC controller determines the first HVAC zone controller detected that the first portable smart device entered communication range for the first HVAC zone more recently than the second HVAC zone controller detected the second portable smart device entered communication range for the second HVAC zone, and the HVAC controller provides for conditioning air for the first group depending on the location of the first device rather than the second device until the second portable smart device leaves communication range of the second HVAC zone controller.

In addition to one or more of the above disclosed features, or as an alternative, the disclosed system includes a motion sensor in the first zone, the motion sensor electronically communicating with the first HVAC zone controller, and the HVAC controller controls the HVAC system to condition air in the first zone when no portable smart devices are detected in the first zone and the motion sensor detects a person in the first zone.

Further disclosed is a method for controlling a system for automatically controlling a Heating, Ventilation and Air Conditioning (HVAC) system with networked HVAC zone sensors, the HVAC system having one more of the above disclosed features.

### BRIEF DESCRIPTION OF THE DRAWINGS

The following descriptions should not be considered limiting in any way. With reference to the accompanying drawings, like elements are numbered alike:

FIG. 1 illustrates a system for controlling a heating, ventilation and air conditioning (HVAC) system with networked HVAC zone sensors according to an embodiment;

FIG. 2 illustrates a process for controlling a heating, ventilation and air conditioning (HVAC) system with networked HVAC zone sensors according to an embodiment;

FIG. 3 illustrates a process for controlling a heating, ventilation and air conditioning (HVAC) system with networked HVAC zone sensors according to an embodiment;

FIG. 4 illustrates a process for controlling a heating, ventilation and air conditioning (HVAC) system with networked HVAC zone sensors according to an embodiment;

FIG. 5 illustrates a process for controlling a heating, ventilation and air conditioning (HVAC) system with networked HVAC zone sensors according to an embodiment;

FIG. 6 illustrates a process for controlling a heating, ventilation and air conditioning (HVAC) system with networked HVAC zone sensors according to an embodiment;

FIG. 7 illustrates a process for controlling a heating, ventilation and air conditioning (HVAC) system with networked HVAC zone sensors according to an embodiment; and

FIG. 8 illustrates a process for controlling a heating, ventilation and air conditioning (HVAC) system with networked HVAC zone sensors according to an embodiment.

### DETAILED DESCRIPTION

A detailed description of one or more embodiments of the disclosed apparatus and method are presented herein by way of exemplification and not limitation with reference to the Figures.

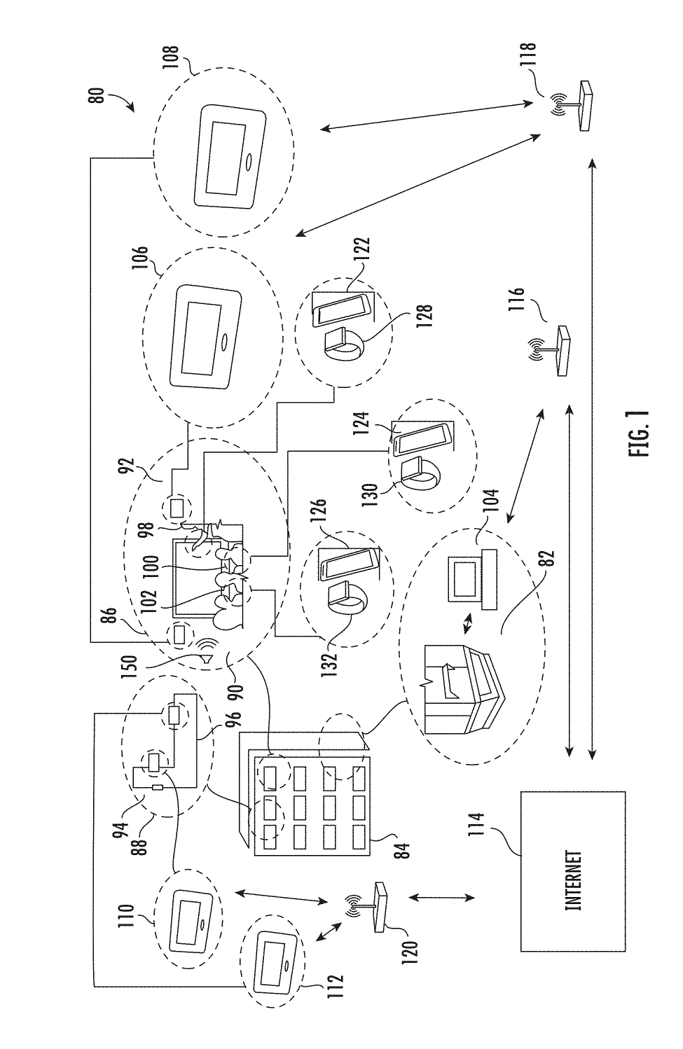

Turning to FIG. 1, a system 80 is illustrated for automatically controlling a HVAC system 82. An office building 84, for example, may contain the HVAC system and may also include a plurality of building partition spaces including an auditorium 86 and a corridor 88. The auditorium 86 may be large enough to be equipped with a first HVAC zone 90 and a second HVAC zone 92. The corridor may be large enough to be equipped with a third zone 94 and a fourth zone 96. Within the auditorium there may be a plurality of people including a first user 98, a second user 100 and a third user 102 for whom the HVAC system 82 creates a conditioned environment.

The system 80 includes a plurality of smart devices, which are electronic devices, generally connected to other devices or networks via different wireless telecommunication protocols and which can operate to some extent interactively and autonomously. Smart devices may be capable of communicating over a local area network (LAN) and/or a private area network (PAN). LAN technologies include WiFi technology, which is a technology based on the Section 802.11 standards from the Institute of Electrical and Electronics Engineers, or IEEE. PAN technology includes, for example, Bluetooth technology, which is a wireless technology standard for exchanging data over short distances using short-wavelength radio waves. Devices that communicate over a LAN may need access to a password to join a LAN using LAN protocols. Devices that communicate over a PAN may initially need to be paired using PAN protocols.

The system 80 includes, for example, an HVAC controller which is a smart HVAC controller 104. The system 80 also includes a plurality of zone controllers which are smart HVAC zone controllers, including a first HVAC zone controller 106 for the first HVAC zone, a second HVAC zone controller 108 for the second HVAC zone, a third zone controller 110 for the third HVAC zone and a fourth zone controller 112 for the fourth HVAC zone. The plurality of zone controllers may communicate with the HVAC controller over a LAN 114 via one or more WiFi access points including a first access point 116 communicating with the HVAC controller, a second access point 118 communicating with the first HVAC zone controller and the second HVAC zone controller, a third access point 120 communicating with the third zone controller and the fourth zone controller. Of course other arrangements related to LAN access for each of the smart controllers are within the scope of the disclosure. In addition, Ethernet communication protocols through wired connections between these devices is part of the disclosure.

The zone controllers may communicate over a plurality of PANs with a plurality of portable smart devices. The plurality of portable smart devices are associated with the plurality of people. That is, each portable smart device communicates individually with each zone controller via a unique PAN.

More specifically, the zone controllers may communicate over a first plurality of PANs with a first plurality of portable smart devices. The first plurality of portable smart devices includes a first portable smart device 122 associated with the first user, a second portable smart device 124 associated with the second user, a third portable smart device 126 associated with the third user. As illustrated, the first plurality of portable smart devices may be mobile phones.

The zone controllers may communicate over a second plurality of PANs with a second plurality of portable smart devices, including a fourth portable smart device 128 associated with the first user, a fifth portable smart device 130 associated with the second user and a sixth portable smart device 132 associated with the third user. As illustrated, the second plurality of portable smart devices are smart watches. Of course other types of portable smart devices capable of communicating over a PAN may be utilized instead or in addition to any of these portable smart devices. For example, as illustrated, or other portable smart devices such laptops, tablets or the like, are within the scope of the disclosure.

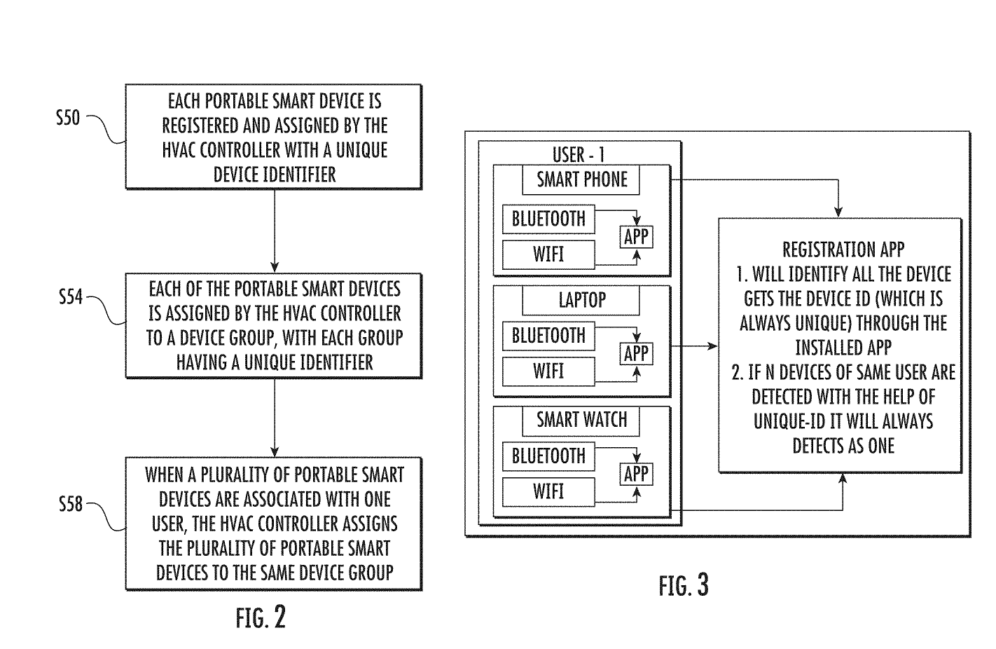

As illustrated in FIGS. 2 and 3, a process for registering each of the portable smart devices with the HVAC controller is illustrated according to a disclosed embodiment. Registration, and deregistration, may be performed by a user using an App available from an App Store, which is a digital distribution platform for distributing computer software applications over the Internet. As illustrated, registration may be performed using WiFi or PAN technologies. At step S50, each portable smart device is registered and assigned by the HVAC controller with a unique device identifier. At step S54, each of the portable smart devices is assigned by the HVAC controller to a device group, with each group having a unique identifier. At step S58, when a plurality of portable smart devices are associated with one user, the HVAC controller assigns the plurality of portable smart devices to the same device group.

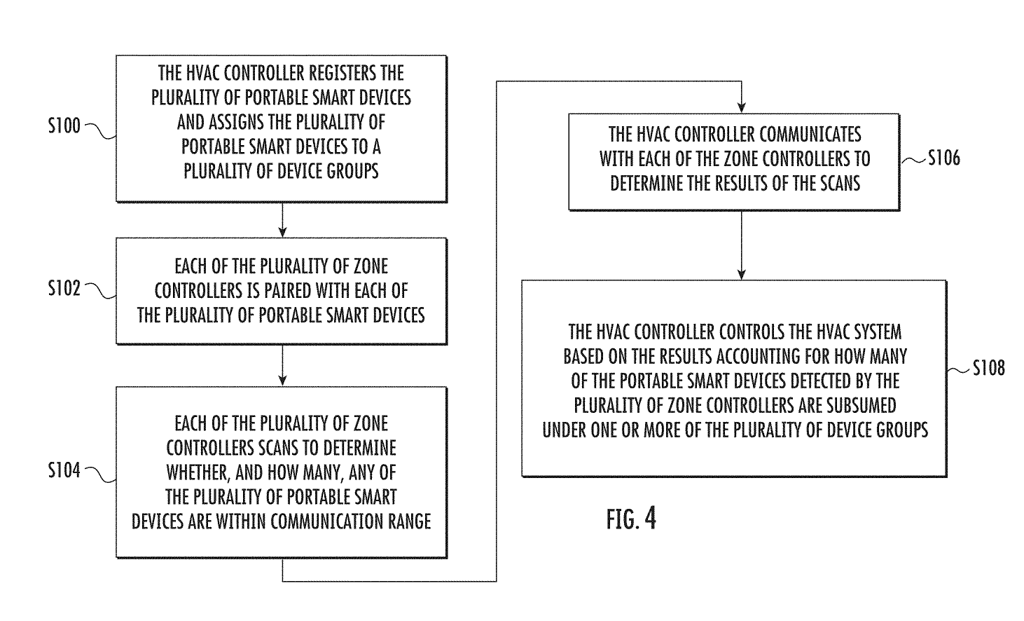

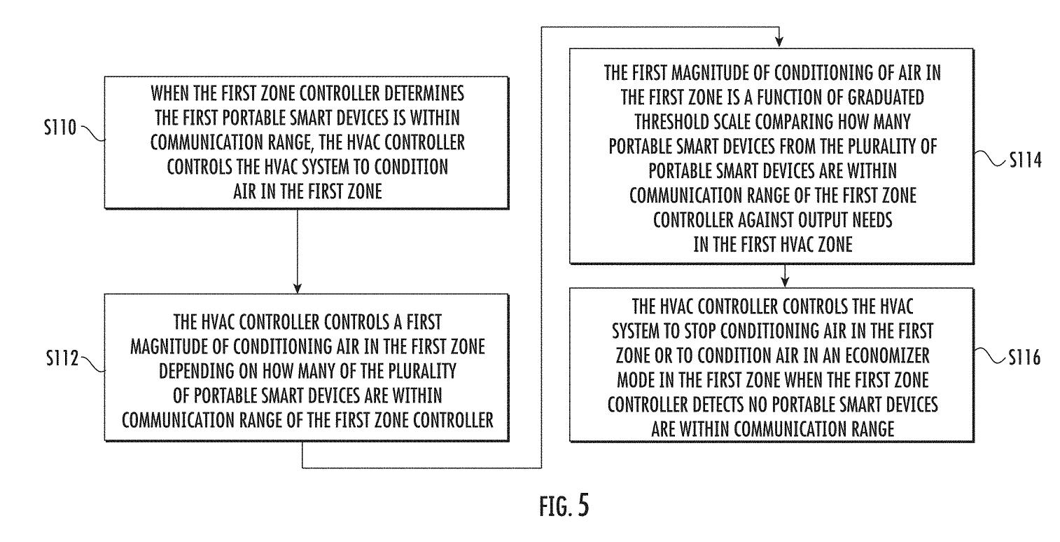

FIG. 4 illustrates a process for the operation of the system illustrated in FIGS. 1-3. At step S100 the HVAC controller registers the plurality of portable smart devices and assigns the plurality of portable smart devices to a plurality of device groups. In one embodiment, the plurality of portable smart devices may be registered with an App that assigns all devices for the user to the phone number of the user. The App directly communicates with the HVAC controller and utilizes the user's phone number as the user's unique identifier for the HVAC controller. In this embodiment, the HVAC controller may not be needed for registration.

At step S102 each of the plurality of zone controllers is paired with each of the plurality of portable smart devices. At step S104 each of the plurality of zone controllers scans to determine whether, and how many of, the plurality of portable smart devices are within communication range. At step S106 the HVAC controller communicates with each of the zone controllers to determine the results of the scans. At step S108 the HVAC controller controls the HVAC system based on the results accounting for how many of the plurality of portable smart devices detected by the plurality of zone controllers are subsumed under one or more of the plurality of device groups.

As indicated, the auditorium includes the first HVAC zone 92, the first HVAC zone controller 106, and the first user 100 has the first portable smart device 122. Turning to FIG. 5, at step S110 when the first HVAC zone controller determines the first portable smart devices is within communication range, the HVAC controller controls the HVAC system to condition air in the first HVAC zone. At step S112 the HVAC controller controls a first magnitude of conditioning air in the first HVAC zone depending on how many portable smart devices from the plurality of portable smart devices are within communication range of the first HVAC zone controller. At step S114 the first magnitude of conditioning of air in the first HVAC zone is a function of graduated threshold scale. The threshold scale compares how many of the plurality of portable smart devices are within communication range of the first HVAC zone controller against output needs in the first HVAC zone. At step S116 the HVAC controller controls the HVAC system to stop conditioning air in the first HVAC zone or to condition air in an economizer mode in the first HVAC zone when the first HVAC zone controller detects no portable smart devices are within communication range.

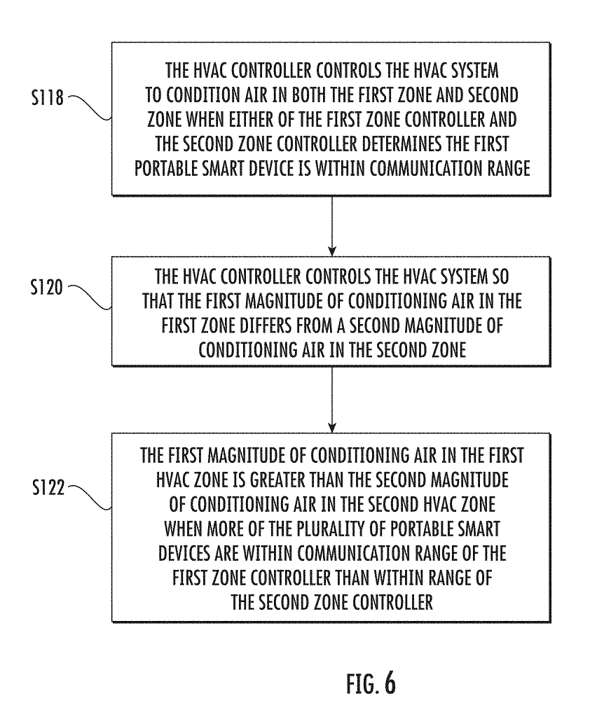

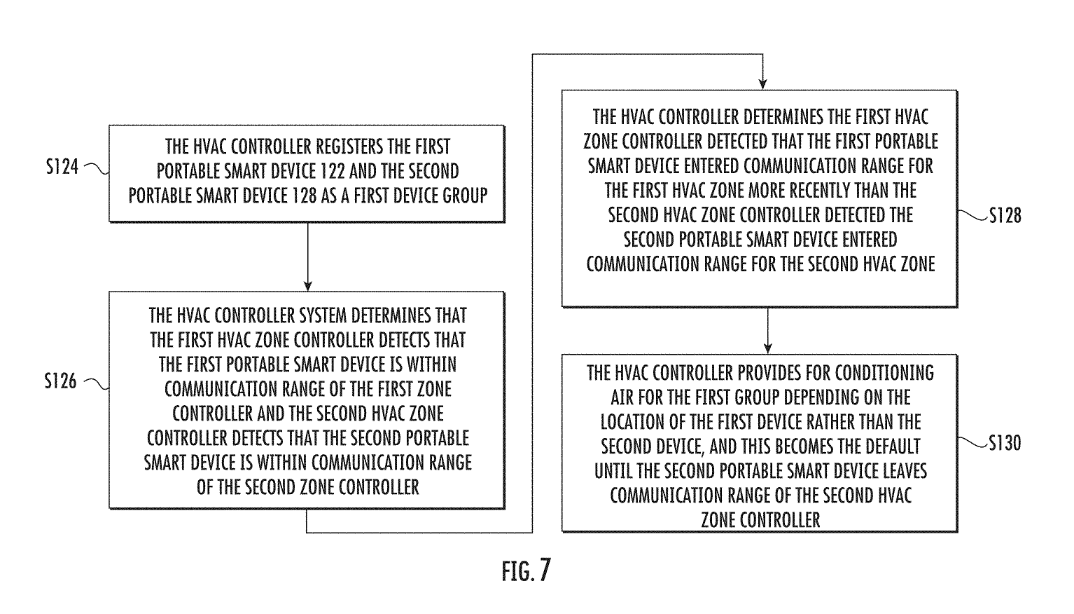

As further indicated, the auditorium 86 is a common building partition space for the first HVAC zone 86, the second HVAC zone 90, the first HVAC zone controller 106 and the second HVAC zone controller 108. Turning to FIG. 6, at step S118 the HVAC controller controls the HVAC system to condition air in both the first HVAC zone and second HVAC zone when either of the first HVAC zone controller and the second HVAC zone controller determines the first portable smart device is within communication range. At step S120 the HVAC controller controls the HVAC system so that the first magnitude of conditioning air in the first HVAC zone differs from a second magnitude of conditioning air in the second HVAC zone. At step S122 the first magnitude of conditioning air in the first HVAC zone is greater than the second magnitude of conditioning air in the second HVAC zone when more of the plurality of portable smart devices are within communication range of the first HVAC zone controller than within range of the second HVAC zone controller.

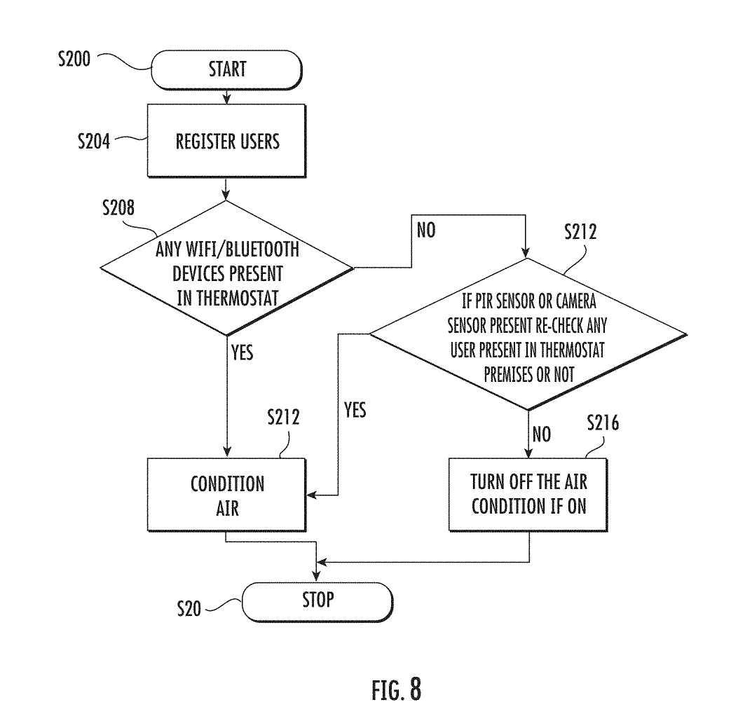

Further discussion will now be provided for step S108 of the HVAC controller accounting for how many of the portable smart devices detected by the plurality of zone controllers are subsumed under one or more of the plurality of device groups. As indicated, the first user 100 may have a first portable smart device 122 and a second portable smart device 128. As illustrated in FIG. 7, at S124 the HVAC controller registers the first portable smart device 122 and the second portable smart device 128 as a first group of portable smart devices. At step S126 the HVAC controller system determines that the first HVAC zone controller detects that the first portable smart device is within communication range of the first zone controller and the second HVAC zone controller detects that the second portable smart device is within communication range of the second zone controller.

At step S128 the HVAC controller determines the first HVAC zone controller detected that the first portable smart device entered communication range for the first HVAC zone more recently than the second HVAC zone controller detected the second portable smart device entered communication range for the second HVAC zone. At step S130 the HVAC controller provides for conditioning air for the first group depending on the location of the first device rather than the second device. This setting becomes the default for the first group until the second portable smart device leaves communication range of the second HVAC zone controller. Thus, if the first user 100 leaves one of the mobile phone 122 or smart watch 128 in any zone and takes the other of the mobile phone or smart watch to a different zone, conditioning of zone which has been vacated by the first user need not continue.

In one embodiment, one or more zones may be fitted with one or more PIR sensors and/or cameras as motion detectors 150 to detect the presence of people in the one or more zones. This way, if users with registered portable smart devices have left a zone, but others without registered portable smart devices are within the zone, proper air conditioned can still be provided. A process for the embodiment is illustrated in FIG. 8. At step S200 the HVAC controller initiates and all portable smart devices are registered at step S204. These steps are similar to the steps described in the above embodiments.

At step S208 the HVAC controller determines whether the HVAC zone controllers detect any registered portable smart devices. At step S212 if a zone controller detects one or more portable smart devices, the HVAC controller conditions air in the zone as described above. If no portable smart devices are detected by the zone controller, but the PIR sensor or camera detects people in the zone, the HVAC controller provides air conditioning to the zone. When no persons are in the zone and no portable smart devices are detected, the HVAC controller will turn off the HVAC system as indicated in step S216. Then at step S220, the system turns off until such time a zone controller or sensor detects a device or user in a zone.

The benefits of the above disclosed system include (1) cost savings compared with installing or positioning or replacing PIR sensors; (2) a relative ease for an HVAC system to detect when to operate through via common WiFi and Bluetooth protocols; and (3) cost savings related to optimized HVAC system usage. It is to be appreciated that the above disclosed zone controllers may be smart thermostats or ZS sensors.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system for automatically controlling a Heating, Ventilation and Air Conditioning (HVAC) system with networked HVAC zone sensors, the HVAC system being within a building, the building containing a plurality of partitioned spaces and a plurality of HVAC zones positionally associated with the plurality of partitioned spaces, the system comprising:
an HVAC controller controlling the HVAC system, a plurality of zone controllers disposed within at least one of the plurality of HVAC zones, the HVAC controller communicating with the plurality of zone controllers via Ethernet protocols and/or local area network (LAN) protocols, and the plurality of zone controllers communicating with a plurality of portable smart devices over a personal area network (PAN),
wherein:
the plurality of portable smart devices are registered with the HVAC controller and assigned to a plurality of device groups,
each of the plurality of zone controllers is paired with each of the plurality of portable smart devices,
each of the plurality of zone controllers scans to determine whether, and how many of, the plurality of portable smart devices are within communication range,
the HVAC controller communicates with each of the zone controllers to determine the results of the scans, and
the HVAC controller controls the HVAC system based on the results accounting for how many of the plurality of portable smart devices detected by the plurality of zone controllers are subsumed under one or more of the plurality of device groups.

2. The system of claim 1 wherein:
the plurality of partitioned spaces includes a first partition space, the plurality of HVAC zones includes a first HVAC zone for conditioning at least a first portion of the first partition space, the plurality of zone controllers includes a first HVAC zone controller positionally associated with the first HVAC zone, and the plurality of portable smart devices includes a first portable smart device, and
wherein:
the HVAC controller controls the HVAC system to condition air in the first HVAC zone when the first HVAC zone controller determines the first portable smart device is within communication range.

3. The system of claim 2 wherein:
the HVAC controller controls a first magnitude of conditioning air in the first HVAC zone depending on how many portable smart devices from the plurality of portable smart devices are within communication range of the first HVAC zone controller.

4. The system of claim 3 wherein:
the first magnitude of conditioning of air in the first HVAC zone is a function of graduated threshold scale comparing how many portable smart devices from the plurality of portable smart devices are within communication range of the first HVAC zone controller against output needs in the first HVAC zone.

5. The system of claim 4 wherein:
the HVAC controller controls the HVAC system to stop conditioning air in the first HVAC zone or to condition air in an economizer mode in the first HVAC zone when the first HVAC zone controller detects no portable smart devices are within communication range.

6. The system of claim 5 wherein:
the plurality of HVAC zones includes a second HVAC zone for conditioning at least a second portion of the first partition space, the plurality of zone controllers includes a second HVAC zone controller positionally associated with the second HVAC zone, and
wherein:
the HVAC controller controls the HVAC system to condition air in both the first HVAC zone and second HVAC zone when either of the first HVAC zone controller and the second HVAC zone controller determines the first portable smart device is within communication range.

7. The system of claim 6 wherein:
the HVAC controller controls the HVAC system so that the first magnitude of conditioning air in the first HVAC zone differs from a second magnitude of conditioning air in the second HVAC zone.

8. The system of claim 7 wherein:
the first magnitude of conditioning air in the first HVAC zone is greater than the second magnitude of conditioning air in the second HVAC zone when more of the plurality of portable smart devices are within communication range of the first HVAC zone controller than within range of the second HVAC zone controller.

9. The system of claim 8 wherein:
the plurality of portable smart devices includes a second portable smart device, and
wherein:
the first portable smart device and the second portable smart device are registered with the HVAC controller as a first group of portable smart devices,
the HVAC controller system determines that the first HVAC zone controller detects that the first portable smart device is within communication range of the first zone controller and the second HVAC zone controller detects that the second portable smart device is within communication range of the second zone controller,
the HVAC controller determines the first HVAC zone controller detected that the first portable smart device entered communication range for the first HVAC zone more recently than the second HVAC zone controller detected the second portable smart device entered communication range for the second HVAC zone, and
the HVAC controller provides for conditioning air for the first group depending on the location of the first device rather than the second device until the second portable smart device leaves communication range of the second HVAC zone controller.

10. The system of claim 9 including a motion sensor in the first zone, the motion sensor electronically communicating with the first HVAC zone controller, and the HVAC controller controls the HVAC system to condition air in the first zone when no portable smart devices are detected in the first zone and the motion sensor detects a person in the first zone

11. A method for controlling a system for automatically controlling a Heating, Ventilation and Air Conditioning (HVAC) system with networked HVAC zone sensors, the HVAC system being within a building, the building containing a plurality of partitioned spaces and a plurality of HVAC zones positionally associated with the plurality of partitioned spaces,
the HVAC system including an HVAC controller, a plurality of zone controllers disposed within at least one the plurality of HVAC zones, the HVAC controller communicating with the plurality of zone controllers via Ethernet protocols and/or local area network (LAN) protocols, and the plurality of zone controllers communicating with a plurality of portable smart devices over a personal area network (PAN),
wherein the method includes:
operating the HVAC controller to register the plurality of portable smart devices and assign the plurality of portable smart devices to a plurality of device groups,
operating each of the plurality of zone controllers to pair with each of the plurality of portable smart devices,
operating each of the plurality of zone controllers to scan to determine whether, and how many of, the plurality of portable smart devices are within communication range,
operating the HVAC controller to communicate with each of the zone controllers to determine the results of the scans, and
operating the HVAC controller to control the HVAC system based on the results accounting for how many of the plurality of portable smart devices detected by the plurality of zone controllers are subsumed under one or more of the plurality of device groups.

12. The method of claim 11 wherein:
the plurality of partitioned spaces includes a first partition space, the plurality of HVAC zones includes a first HVAC zone for conditioning at least a first portion of the first partition space, the plurality of zone controllers includes a first HVAC zone controller positionally associated with the first HVAC zone, and the plurality of portable smart devices includes a first portable smart device, and
wherein the method includes:
operating the HVAC controller to control the HVAC system to condition air in the first HVAC zone when the first HVAC zone controller determines the first portable smart devices is within communication range.

13. The method of claim 12 wherein the method includes:
operating the HVAC controller to control a first magnitude of conditioning air in the first HVAC zone depending on how many portable smart devices from the plurality of portable smart devices are within communication range of the first HVAC zone controller.

14. The method of claim 13 wherein:
the first magnitude of conditioning of air in the first HVAC zone is a function of graduated threshold scale comparing how many portable smart devices from the plurality of portable smart devices are within communication range of the first HVAC zone controller against output needs in the first HVAC zone.

15. The method of claim 14 wherein the method includes:
operating the HVAC controller to control the HVAC system to stop conditioning air in the first HVAC zone or to condition air in an economizer mode in the first HVAC zone when the first HVAC zone controller detects no portable smart devices are within communication range.

16. The method of claim 15 wherein:
the plurality of HVAC zones includes a second HVAC zone for conditioning at least a second portion of the first partition space, the plurality of zone controllers includes a second HVAC zone controller positionally associated with the second HVAC zone, and
wherein the method includes:
operating the HVAC controller to control the HVAC system to condition air in both the first HVAC zone and second HVAC zone when either of the first HVAC zone controller and the second HVAC zone controller determines the first portable smart device is within communication range.

17. The method of claim 16 wherein the method includes:
operating the HVAC controller to control the HVAC system so that the first magnitude of conditioning air in the first HVAC zone differs from a second magnitude of conditioning air in the second HVAC zone.

18. The method of claim 17 wherein:
the first magnitude of conditioning air in the first HVAC zone is greater than the second magnitude of conditioning air in the second HVAC zone when more of the plurality of portable smart devices are within communication range of the first HVAC zone controller than within range of the second HVAC zone controller.

19. The method of claim 18 wherein:
the plurality of portable smart devices includes a second portable smart device, and
wherein the method includes:
operating the HVAC controller to register the first portable smart device and the second portable smart device as a first group of portable smart devices,
operating the HVAC controller system to determine that the first HVAC zone controller detects that the first portable smart device is within communication range of the first zone controller and the second HVAC zone controller detects that the second portable smart device is within communication range of the second zone controller,
operating the HVAC controller to determine the first HVAC zone controller detected that the first portable smart device entered communication range for the first HVAC zone more recently than the second HVAC zone controller detected the second portable smart device entered communication range for the second HVAC zone, and
operating the HVAC controller to provide for conditioning air for the first group depending on the location of the first device rather than the second device until the second portable smart device leaves communication range of the second HVAC zone controller.

20. The method of claim 19 including a motion sensor in the first zone, the motion sensor electronically communicating with the first HVAC zone controller, and the HVAC controller controls the HVAC system to condition air in the first zone when no portable smart devices are detected in the first zone and the motion sensor detects a person in the first zone.
